(19) United States
(12) Patent Application Publication
(10) Pub. No.: US 2014/0355138 A1
(43) Pub. Date: Dec. 4, 2014

(54) LENS BARREL AND IMAGING APPARATUS

(71) Applicant: Sony Corporation, Tokyo (JP)

(72) Inventor: Itaru Doi, Tokyo (JP)

(73) Assignee: SONY CORPORATION, Tokyo (JP)

(21) Appl. No.: 14/259,321

(22) Filed: Apr. 23, 2014

(30) Foreign Application Priority Data
May 31, 2013 (JP) 2013-116130

(51) Int. Cl. G03B 15/02; G03B 15/06; G03B 17/14; G02B 7/04

(52) U.S. Cl. CPC G03B 15/02; G02B 7/04; G03B 15/06; G03B 17/14
USPC 359/817; 359/823; 362/3; 362/16; 396/529

(57) ABSTRACT

A lens barrel includes: a barrel body; an optical element inside the barrel body; and a wiring which is inserted inside the barrel body, and at least a part of which has a three-dimensional curve shape capable of extending and contracting in a direction of an optical axis of the optical element.

### CROSS REFERENCE TO RELATED APPLICATIONS

This application claims the benefit of Japanese Priority Patent Application JP 2013-116130 filed on May 31, 2013, the entire contents of which are incorporated herein by reference.

### BACKGROUND

The present disclosure relates to a collapsible or interchangeable lens barrel, and an imaging apparatus that includes such a lens barrel.

To illuminate a photographic subject brightly in macro photographing (proximity photographing), an illuminating device (macro light) such as an LED (Light-Emitting Diode) may be occasionally used at the periphery of a lens that is disposed in the nearest distance from the subject. Supply of electric power is carried out via a folding wiring by the use of a flexible flat cable, a flexible wiring board, or the like (for example, see Japanese Unexamined Patent Application Publication Nos. 2003-233109 and 2005-301217).

### SUMMARY

In an imaging apparatus having a flexible optics system, such a folding wiring is usable in a folded state. On the other hand, in an imaging apparatus having an extendable lens barrel, such as a collapsible lens barrel, it is anticipated that a wiring will become transformed to some extent from a folded state in association with an extending and contracting operation of the lens barrel. However, a configuration for supplying electric power in consideration of such transformation of a wiring that may be caused in association with the extending and contracting operation of the lens barrel has not been proposed to date.

It is desirable to provide a lens barrel capable of improving the transformation properties of a wiring, and an imaging apparatus that includes such a lens barrel.

According to an embodiment of the present disclosure, there is provided a lens barrel, including: a barrel body; an optical element inside the barrel body; and a wiring which is inserted inside the barrel body, and at least a part of which has a three-dimensional curve shape capable of extending and contracting in a direction of an optical axis of the optical element.

In the lens barrel according to the embodiment of the present disclosure, at least a part of the wiring has a three-dimensional curve shape capable of extending and contracting in an optical axis direction of the optical element. Therefore, the wiring is transformable in a manner to return to an original form thereof after extending and contracting in the optical axis direction of the optical element, and then to extend and contract in the optical axis direction of the optical element one again.

According to an embodiment of the present disclosure, there is provided an imaging apparatus provided with a lens barrel, the lens barrel including: a barrel body; an optical element inside the barrel body; and a wiring which is inserted inside the barrel body, and at least a part of which has a three-dimensional curve shape capable of extending and contracting in a direction of an optical axis of the optical element.

In the imaging apparatus according to the embodiment of the present disclosure, a subject image is formed by the optical element that is provided inside the barrel body of the lens barrel.

According to the lens barrel or the imaging apparatus of the respective embodiments of the present disclosure, at least a part of the wiring has a three-dimensional curve shape capable of extending and contracting in the optical axis direction of the optical element, which allows the transformation properties of the wiring to be improved. Above all, such an effect is preferred for application to an extendable lens barrel, such as a collapsible lens barrel, and it is possible to transform the wiring in a manner to properly move on with an extending and contracting operation of the lens barrel.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the present disclosure, and are incorporated in and constitute a part of this specification. The drawings illustrate embodiments and, together with the specification, serve to explain the principles of the present technology.

FIG. 1 is a perspective view showing an external appearance of an imaging apparatus according to a first embodiment of the present disclosure that is viewed from the front side.

FIG. 2 is a perspective view showing a state where a lens barrel illustrated in FIG. 1 is moved forward to extend ahead.

FIG. 3 is a perspective view showing an external appearance of the imaging apparatus illustrated in FIG. 1 that is viewed from the rear side.

FIG. 4 is a schematic block diagram showing a control system of the imaging apparatus illustrated in FIG. 1.

FIG. 5 is a perspective view of an external appearance showing the lens barrel placed at a photographing position illustrated in FIG. 2 apart from a main unit.

FIG. 6 is a front view of the lens barrel illustrated in FIG. 2 that is viewed from the front side.

FIG. 7 is a perspective view showing an internal configuration of the lens barrel by cutting a part of a barrel body illustrated in FIG. 2.

FIG. 8 is a plan view showing a configuration of a movable part illustrated in FIG. 7.

FIG. 9 is a perspective view of an external appearance showing the lens barrel placed at a storing position illustrated in FIG. 1 apart from a main unit.

FIG. 10 is a perspective view showing an internal configuration of the lens barrel by cutting a part of the barrel body illustrated in FIG. 9.

FIG. 11 is a perspective view showing an internal configuration of the lens barrel by further cutting a part of the barrel body illustrated in FIG. 10.

FIG. 12 is a plan view showing a configuration of a movable part according to a modification example 1.

FIG. 13 is a perspective view showing a state at a photographing position of the movable part illustrated in FIG. 12.

FIG. 14 is a perspective view showing a state at a storing position of the movable part illustrated in FIG. 12.

FIG. 15 is a plan view showing a configuration of a movable part according to a modification example 2.

FIG. 16 is a perspective view showing a configuration of a lens barrel according to a second embodiment of the present disclosure.

FIG. 17 is a perspective view showing an external appearance of a lens barrel according to a third embodiment of the present disclosure.

FIG. 18 is an exploded perspective view of a part of the lens barrel illustrated in FIG. 17.

FIG. 19 is a perspective view showing an external appearance of a lens barrel according to a fourth embodiment of the present disclosure.

FIG. 20 is a perspective view showing an internal configuration of the lens barrel illustrated in FIG. 19.

### DETAILED DESCRIPTION

Hereinafter, some embodiments of the present disclosure are described in details with reference to the drawings. It is to be noted that the description is provided in the order given below.

1. First Embodiment (an example where a flexible wiring board has a movable part in a spiral form)
2. Modification Example 1 (an example where a planar shape of a movable part is a volute form of going around an optical axis by more than one turn)
3. Modification Example 2 (an example where a planar shape of a movable part is an arc-like form of going around an optical axis by less than one turn)
4. Second Embodiment (an example where an electronic component mounting section of a flexible wiring board is made removable with respect to a movable part)
5. Third Embodiment (an example where a diffusion element is provided at the front of an illuminating device)
6. Fourth Embodiment (an example of an interchangeable lens barrel)

### 1. First Embodiment

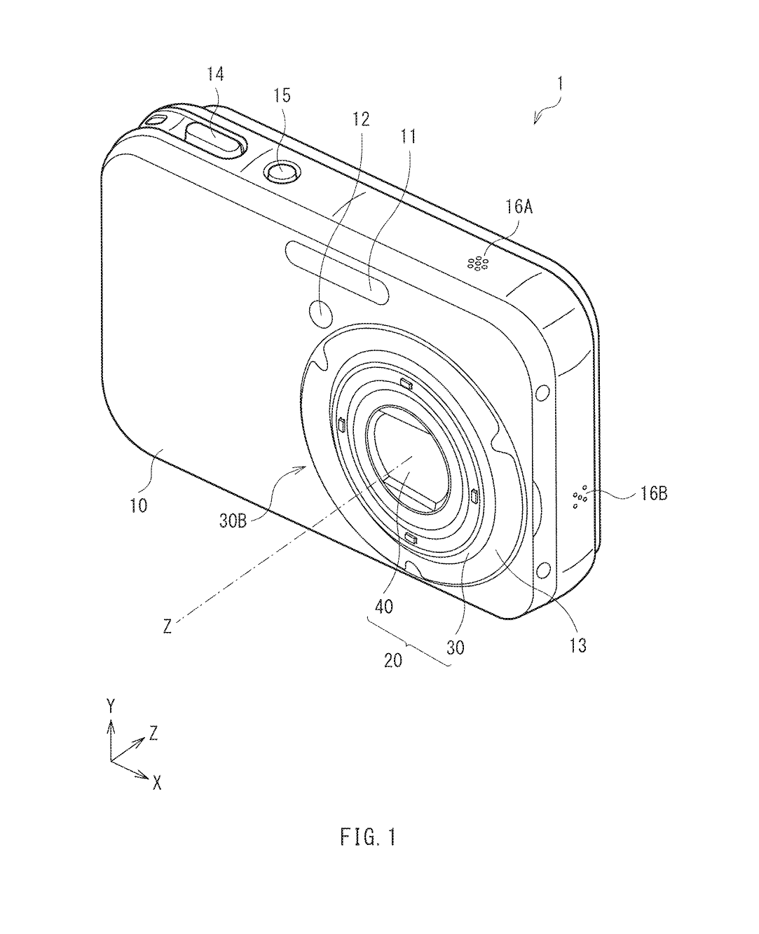

FIG. 1 shows an external appearance of an imaging apparatus (digital still camera) according to a first embodiment of the present disclosure that is viewed from the front side. This imaging apparatus 1 may have, for example, a lens barrel 20 having a collapsible mechanism that is attached on a surface on the photographic subject side (front side) of a main unit 10. In the vicinity of the lens barrel 20, a flash 11 for generating photography support light, and a self-timer lamp 12 are disposed.

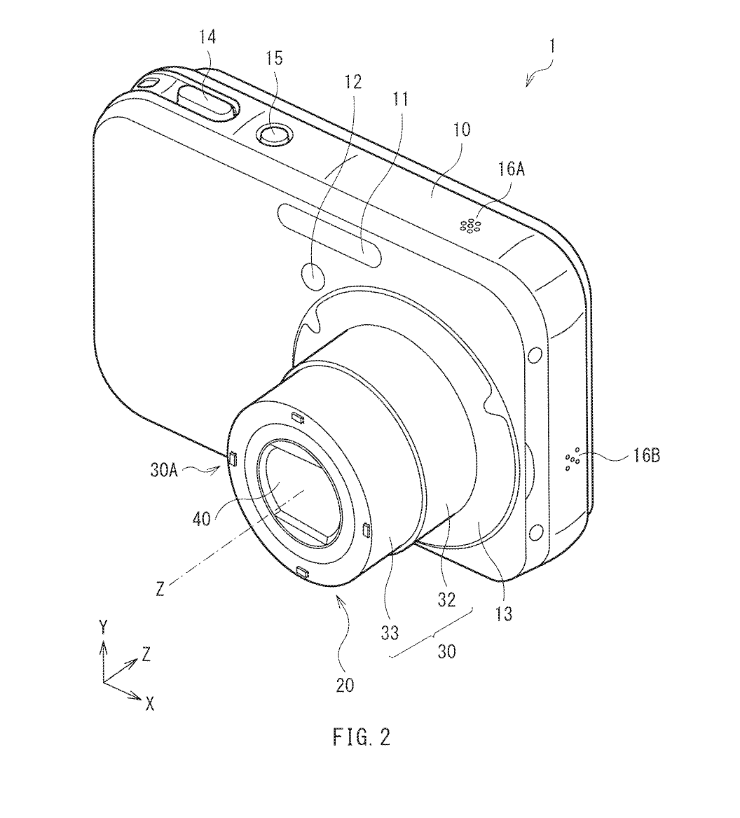

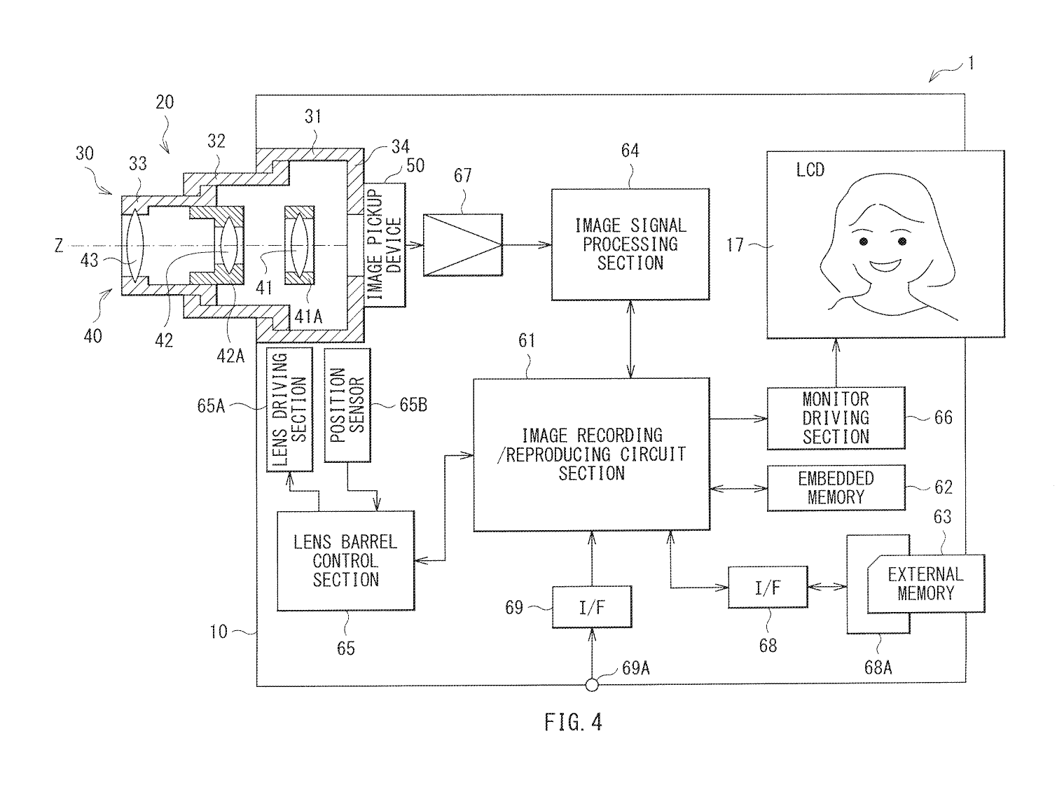

The lens barrel 20 has an optical element 40 such as a photographing lens, and an image pickup device 50 (not shown in FIG. 1, see FIG. 4) inside a barrel body 30. This lens barrel 20 is a collapsible type capable of performing an extending and contracting operation between a photographing position 30A (wide-angle state, telescopic state, and an intermediate state between the above-described status) where the barrel body 30 moves forward to extend ahead from the main unit 10 as shown in FIG. 2 and a storing position (collapsible position) 30B where the barrel body 30 moves backward to be embedded into the main unit 10 as shown in FIG. 1.

Here, in the present specification, a front side is defined as an object side or a subject side in an optical axis Z direction of the optical element 40, and a rear side is defined as an image side or the image pickup device 50 side. Further, a long-side direction of the main unit 10 is defined as a horizontal camera direction X, and a short-side direction of the main unit 10 is defined as a vertical camera direction Y.

The barrel body 30 is provided at a position displaced slightly from the center on the front side of the main unit 10 to be fitted into a dressed ring 13. The barrel body 30 is capable of performing the extending and contracting operation along the optical axis Z direction between the photographing position 30A shown in FIG. 2 and the storing position (collapsible position) 30B shown in FIG. 1. At the storing position 30B, an almost whole area of the front side (forefront surface) of the barrel body 30 forms the same or almost the same plane as the front side of the main unit 10.

The optical element 40 is capable of moving in the optical axis Z direction between the photographing position 30A shown in FIG. 2 and the storing position (collapsible position) 30B shown in FIG. 1 through operation of a lens driving section 65A (not shown in FIG. 1, see FIG. 4) that is built into the main unit 10. Further, the optical element 40 is capable of being displaced in the optical axis Z direction in association of the extending and contracting operation of the barrel body 30 or by operation of an optical zooming button 18B.

The image pickup device 50 takes a subject image that is formed by the optical element 40, and is configured of a CCD (Charge-Coupled Device) or CMOS (Complementary Metal Oxide Semiconductor) image sensor, or the like.

On the topmost side of the main unit 10, there are provided a shutter button 14 for performing image pickup, a power button 15, sound collection holes 16A for a sound collector such as a microphone, and the like. On one lateral side of the main unit 10, there are provided grating holes 16B for a speaker.

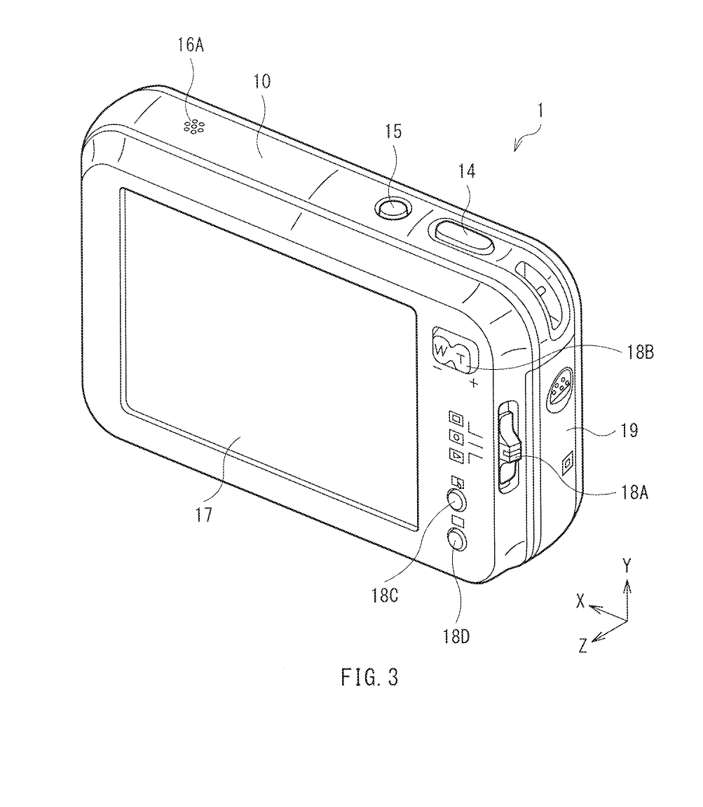

FIG. 3 shows an external appearance of the imaging apparatus 1 that is viewed from the rear side. On the rear side of the main unit 10, a display section 17 is provided. The display section 17 may be configured of, for example, an LCD (liquid crystal display device), and has a touch panel function for menu selection and the like.

On one end side of the rear side of the main unit 10, various operation switches are disposed. Examples of the operation switches may include a mode changeover switch 18A for selecting function modes (still image, motion, image reproduction, and the like), an optical zooming button 18B for adjusting zoom of an optical element 22, a menu button 18C for selecting various menus, and a display switching button 18D for switching screen display. In addition, it is also possible to provide a directional key for moving a cursor or the like for menu selection, a screen button for switching a screen size or removing screen display, and the like. It is to be noted that when the display section 17 has a touch panel function, the menu button 18C may be omitted. On the other lateral side of the main unit 10, there is provided a battery housing section in which a battery serving as a power supply is housed in a removable manner. A battery lid 19 is engaged with the battery housing section in an openable and closable manner.

FIG. 4 shows a control system of the imaging apparatus 1. The imaging apparatus 1 may have, for example, the lens barrel 20, the display section 17, an image recording/reproducing circuit section 61, an embedded memory 62, an external memory 63, an image signal processing section 64, a lens barrel control section 65, a monitor driving section 66, an amplifier 67, a first interface 68, and a second interface 69.

The image recording/reproducing circuit section 61 includes an arithmetic operational circuit having a microcomputer (CPU: Central Processing Unit), for example, and controls the image signal processing section 64, the monitor driving section 66, or the lens barrel control section 65 in response to operation of the shutter button 14, the optical zooming button 18B, the power button 15, a touch panel of the display section 17, and the like. To the image recording/reproducing circuit section 61, each of the embedded memory 62, the image signal processing section 64, the lens barrel control section 65, the monitor driving section 66, the amplifier 67, as well as the first and second interfaces (I/F) 68 and 69 is connected.

The embedded memory 62 has a RAM (Random Access Memory), a ROM (Read-Only Memory), and the like that are used as a program memory, a data memory, and the like for driving the image recording/reproducing circuit section 61. The external memory 63 is used for extending the storage capacity.

The image signal processing section 64 generates image data on the basis of an image pickup signal that is provided as an output from the image pickup device 50 to input such data to the image recording/reproducing circuit section 61. The image signal processing section 64 is connected with the image pickup device 50 mounted on the lens barrel 20 via the amplifier 67.

The lens barrel control section 65 performs a drive control of the lens barrel 20. A lens driving section 65A and a position sensor 65B are connected with the lens barrel control section 65. The lens driving section 65A is a part serving to perform zooming operation and focusing operation in the lens barrel 20. The position sensor 65B detects a position of the optical element 40 in the optical axis Z direction to provide resultant positional information to the lens barrel control section 65.

The display section 17 is connected with the image recording/reproducing circuit section 61 via the monitor driving section 66. The monitor driving section 66 performs a drive operation to display image data on the display section 17.

A connector 68A is connected with the first interface 68, and it is possible to connect the external memory 63 with this connector 68A detachably. A connection terminal 69A that is provided on the main unit 10 is connected with the second interface 69.

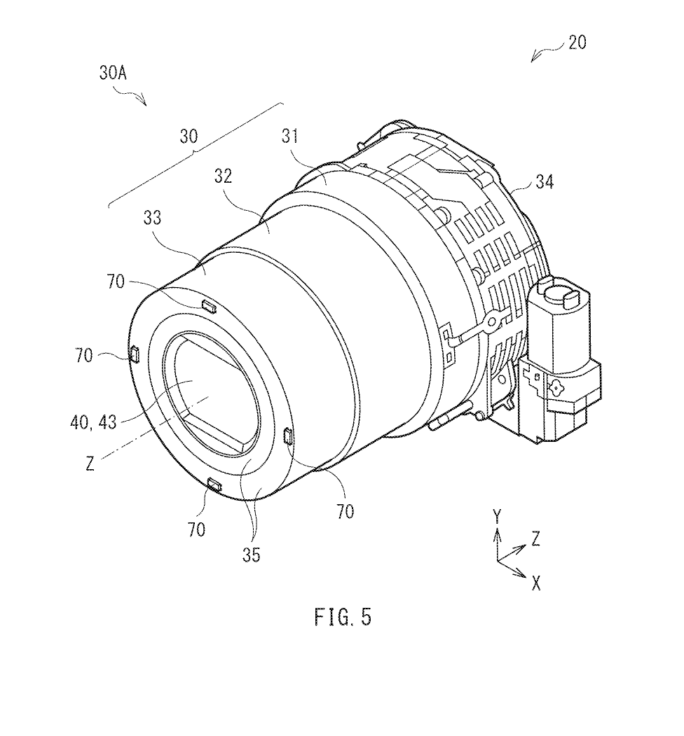

FIG. 5 shows an external appearance of the lens barrel 20 in an extending state. The barrel body 30 has a first part 31, a second part 32, and a third part 33 in this order from the backward. For example, as shown in FIG. 4, the optical element 40 may have a first lens group 41, a second lens group 42, and a third lens group 43 in this order from the backward. The first lens group 41 is held by a first lens frame 41A inside the first part 31. The second lens group 42 is held by a second lens frame 42A inside the second part 32. The third lens group 43 is held by the third part 33.

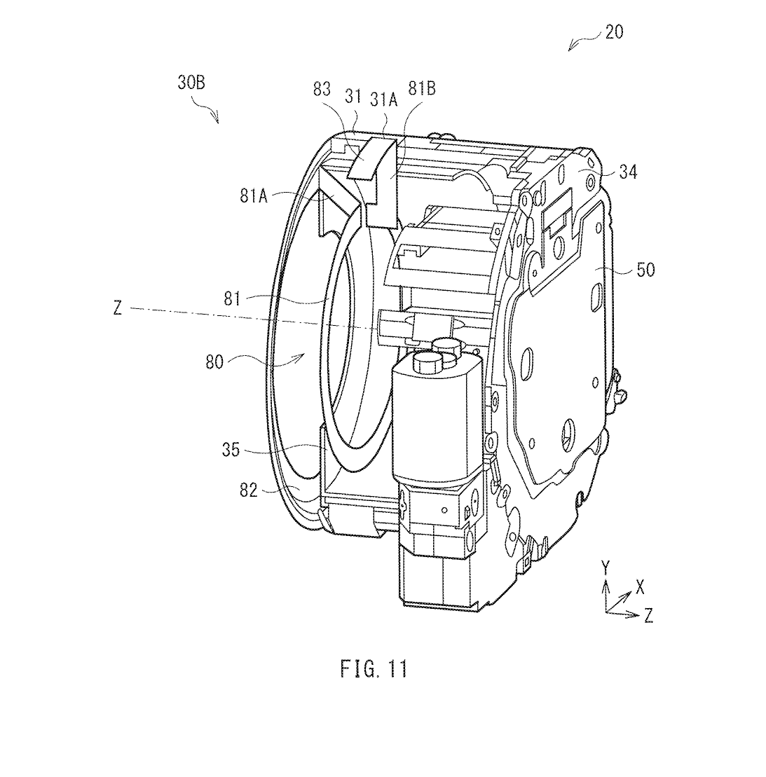

The first part 31 is a securing ring that is fixed to the main unit 10. At the rear side of the first part 31 (on a rear end surface of the barrel body 30), a rear crowing member 34 is fixed detachably by means of a plurality of captive screws (not shown in the drawing). A through-hole in an almost quadrangular shape is provided at a center of the rear crowing member 34, and the image pickup device 50 is mounted into this through-hole (see FIG. 4 and FIG. 11).

The second part 32 has a dual barrel structure having a rotating ring (not shown in the drawing) at an outer side and a linear guide ring (not shown in the drawing) at an inner side, for example. The rotating ring is rotatable around the optical axis Z with respect to the first part 31, and is movable linearly in the optical axis Z direction. The linear guide ring is movable linearly in the optical axis Z direction without rotating with respect to the first part 31. The rotating ring and the linear guide ring are movable linearly in such a manner that the linear guide ring is not restricted by rotation of the rotating ring by using, for example, bayonet fitting. Further, for movement of the rotating ring in the optical axis Z direction, the linear guide ring is also movable in an integrated manner.

The second lens frame 42A serves to move the second lens group 42 while holding it. The second lens frame 42A is movable linearly in the optical axis Z direction without rotating with respect to the first part 31.

The third part 33 has a function serving as a lens holding and moving frame that moves the third lens group 43 while holding it. The third part 33 is movable linearly in the optical axis Z direction without rotating with respect to the first part 31. Further, the third part 33 has a function serving as a dressed ring for improving the appearance of the lens barrel 20. As a material for the third part 33, a variety of metallic materials, such as aluminum alloy and stainless steel may be preferable. However, an engineering plastic material may be used alternatively.

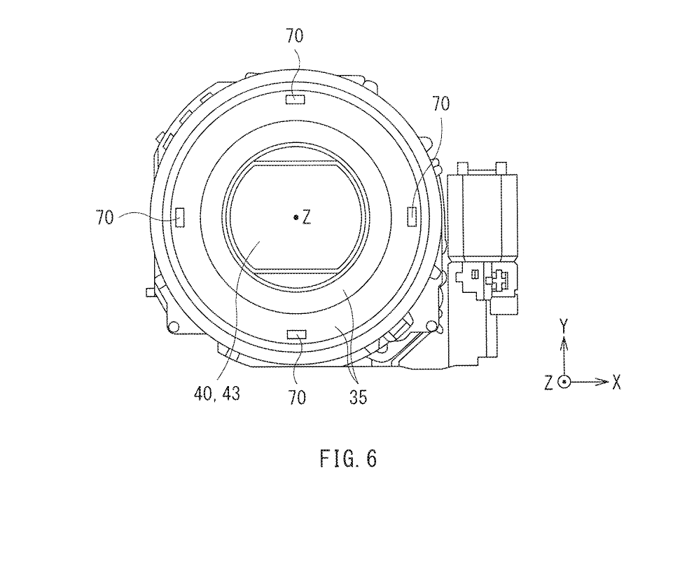

As shown in FIG. 6, a front crowning member 35 is provided on the front end of the third part 33. The front crowning member 35 protects a barrier unit (not shown in the drawing) that is provided on the front end of the lens barrel 20, and is provided in a circular pattern around the optical element 40. The barrier unit closes an optical path serving as a photographing aperture to protect the optical element 40 when photographing is not performed.

Further, an illuminating device 70 is attached to the front crowning member 35. The illuminating device 70 is a so-called macro light that supports proper photographing by illuminating a subject brightly in proximity photographing (macro photographing). The illuminating device 70 may be configured of, for example, a point light source such as an LED, and is disposed at the periphery of the optical element 40. More specifically, the plurality of illuminating devices 70 are disposed at regular spacing intervals (for example, four devices may be arranged at 90-degree intervals) in a circumferential direction of the optical element 40.

It is to be noted that the illuminating device 70 is not only attached to the front crowning member 35, but may be also disposed at another location, such as the front side of the main unit 10. However, by providing the illuminating device 70 on the front crowning member 35, it is possible to dispose the illuminating devices 70 at the periphery of the third lens group 43 that is arranged in the nearest distance from a subject among component parts of the optical element 40. Further, it is also possible to avoid an issue that the lens barrel 20 extending long in a photographing state may block light from the illuminating device 70, causing a shadow to be cast on a subject. In addition, also from a viewpoint of the purpose of macro photographing, a distance between the illuminating device 70 and a subject may be preferably reduced as much as possible.

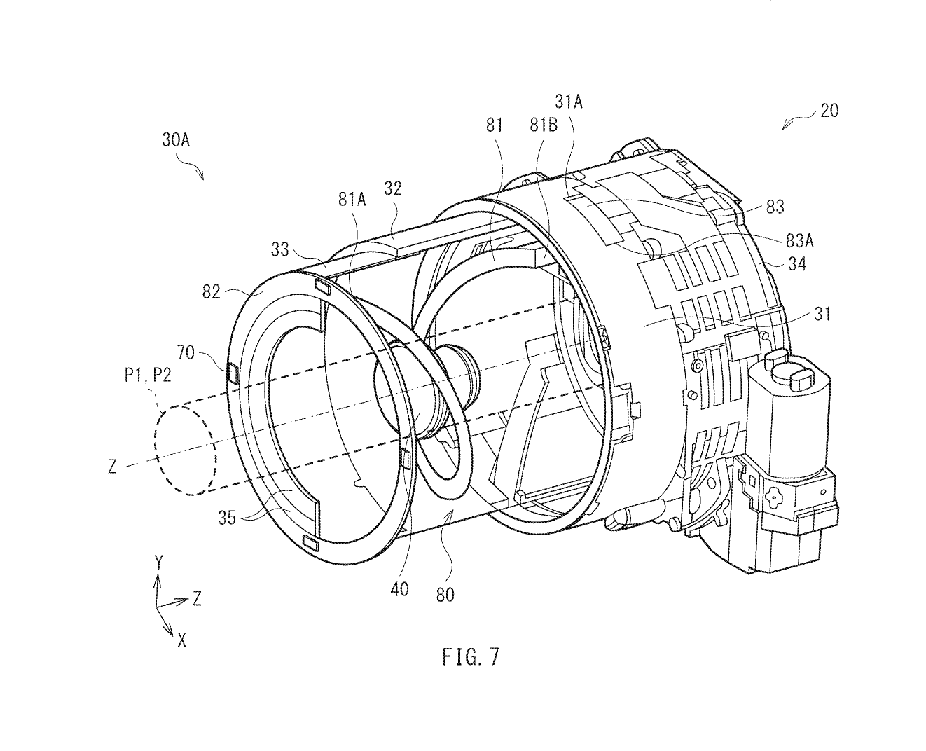

FIG. 7 shows an internal configuration of the lens barrel 20 by longitudinally cutting the second part 32 and the third part 33 of the barrel body 30 illustrated in FIG. 5. Inside the barrel body 30, a wiring 80 is inserted. The wiring 80 is used to supply electric power to the illuminating device 70 from the main unit 10. At least a part of this wiring 80 has a three-dimensional curve shape capable of extending and contracting in the optical axis Z direction of the optical element 40. This allows the transformation properties of the wiring 80 to be improved in the imaging apparatus 1.

More specifically, the wiring 80 has a movable part 81. This movable part 81 is disposed along an internal surface of the barrel body 30, and may be preferably transformable in a manner to avoid an optical path P1 of a bundle of rays (collection of rays) that passes through the optical element 40. This is because it is possible to reduce an issue that the wiring 80 may protrude into the optical path P1 at the time of transformation to disturb the optical path P1.

Further, the wiring 80 may be preferably transformable in a manner to avoid a traveling path P2 of the optical element 40. This is because it is possible to reduce an issue that the optical element 40 and the wiring 80 may interfere with each other during zooming operation and focusing operation, causing traveling of the optical element 40 to be disturbed.

The movable part 81 may be preferably disposed in a spiral form around the optical axis Z of the optical element 40. In such a manner, the movable part 81 is capable of extending and contracting like a coil spring at a clearance between the barrel body 30 and the optical element 40. This assures an extending and contracting distance of the movable part 81 while saving a space involved in transformation of the movable part 81, and reduces a concern about a possibility that the transformation of the movable part 81 will disturb the extending and contracting operation of the lens barrel 20 and travelling of the optical element 40. Here, the “spiral form” means a three-dimensional curve shape that rotates around the optical axis Z the optical element 40 and moves in the optical axis Z direction of the optical element 40.

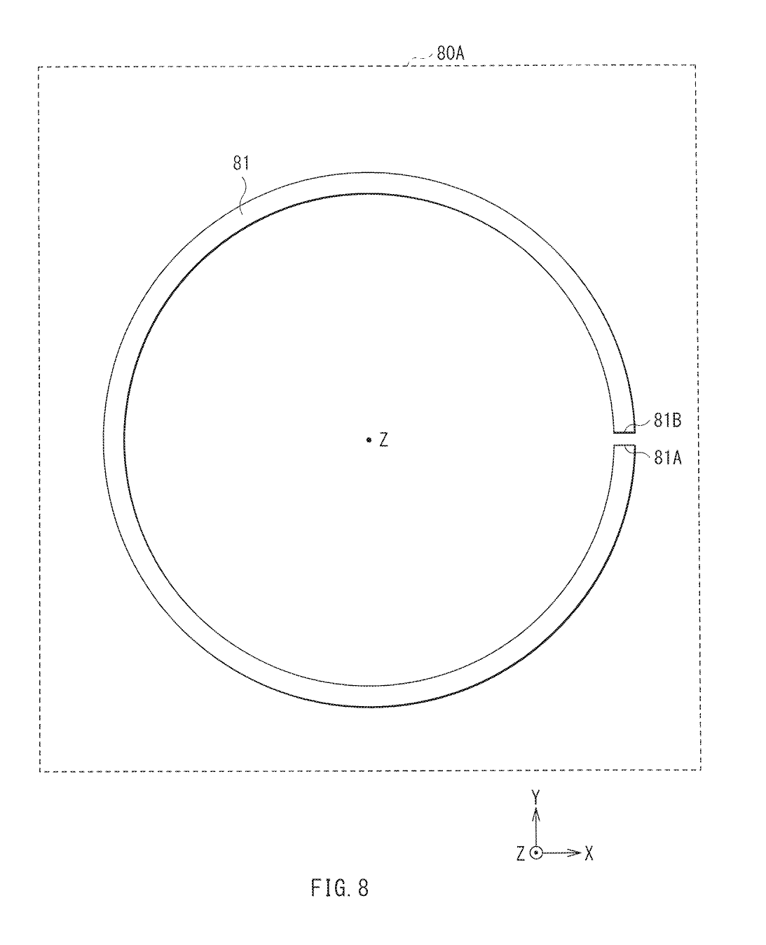

For example, as shown in FIG. 8, such a movable part 81 may be preferably in a circular form of going around the optical axis Z of the optical element 40 by one turn in plane of a piece of flexible wiring board 80A. This makes it possible to reduce a space occupied by the wiring 80 in the storing position 30B, which contributes reduction in size and thickness of the imaging apparatus 1. Further, by cutting out a piece of the flexible wiring board 80A in a circular pattern, it is possible to configure the movable part 81 with ease. It is to be noted that the optical axis Z may be located at a center of the circular movable part 81 as shown in FIG. 8, or may be located at a position (not shown in the drawing) that is displaced from a center of the circular movable part 81.

Further, the wiring 80 also has an electronic component mounting section 82 at a first end 81A of the movable part 81, and a securing section 83 at a second end 81B of the movable part 81.

The electronic component mounting section 82 is connected with the movable part 81 in an integrated manner to form an interrupted series of the wiring 80. An LED chip configuring the illuminating device 70 is mounted on the electronic component mounting section 82, which is fixed to the front crowning member 35 of the third part 33. It is to be noted that the illuminating device 70 may be fixed directly to the front crowning member 35 of the third part 33 alternatively.

The securing section 83 is fixed to the barrel body 30. More specifically, the securing section 83 is led out to the outside of the barrel body 30 from a wiring outlet 31A of the first part 31. An end 83A of the securing section 83 serves as a portion for connection with the main unit 10, and is electrically connected with circuits inside the main unit 10.

It is to be noted that FIG. 7 shows a case where each of the ends 81A and 81B has a linear or polygonal line shape. However, each of the ends 81A and 81B may have a spiral form that is continued to the movable part 81.

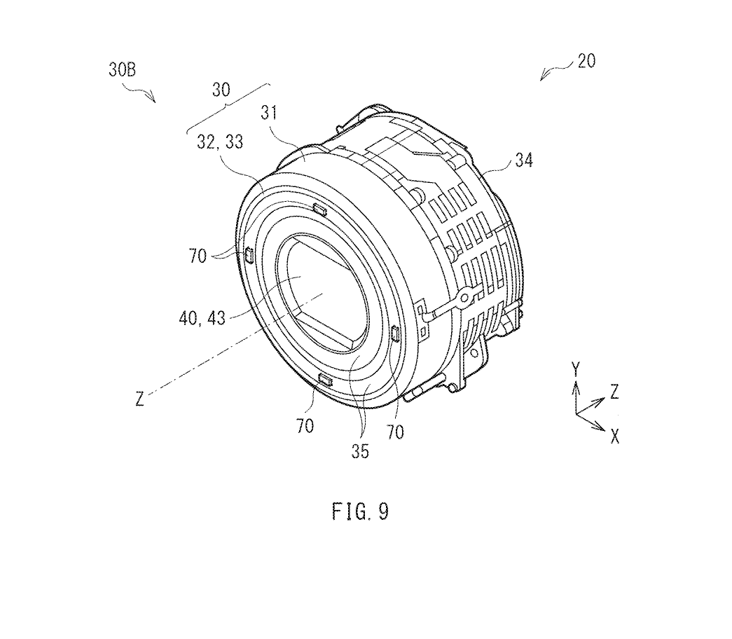

FIG. 9 shows an external appearance of the lens barrel 20 at the storing position (collapsible position) 30B. The second part 32 and the third part 33 of the barrel body 30 are put in a state of being embedded into the first part 31. The wiring 80 is stored in the main unit 10 together with the barrel body 30 and the optical element 40.

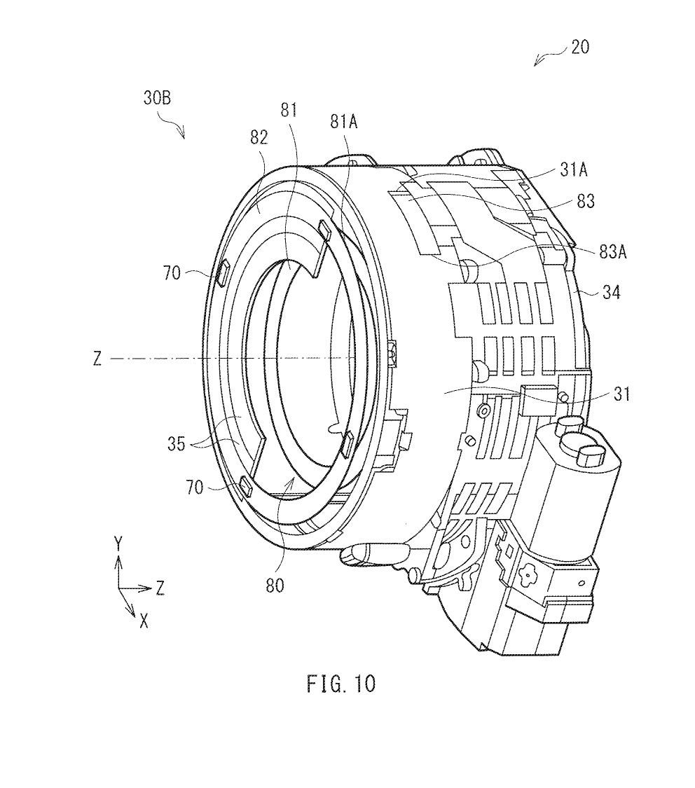

FIG. 10 shows an internal configuration of the lens barrel 20 by cutting the front crowning member 35 of the barrel body 30 illustrated in FIG. 9. To further clarify the illustration, FIG. 11 shows the internal configuration of the lens barrel 20 by longitudinally cutting the first part 31 of the barrel body 30 illustrated in FIG. 10. At the storing position (collapsible position) 30B, the movable part 81 is put in an initial state of forming a circular shape in one plane as shown in FIG. 8 in such a manner that both ends 81A and 81B come close as shown in FIG. 10 and FIG. 11.

In this imaging apparatus 1, when a user pushes the power button 15 to turn the power on, the lens barrel 20 is automatically extended from the storing position (collapsible position) 30B shown in FIG. 1 to the photographing position 30A shown in FIG. 2. At the same time, the barrier unit (not shown in the drawing) that is provided on the front end of the lens barrel 20 is released to enter into a photographable state.

Here, the wiring 80 is inserted into the barrel body 30, and at least a part of the wiring 80 has a three-dimensional curve shape capable of extending and contracting in the optical axis Z direction of the optical element 40. More specifically, the movable part 81 is disposed in a spiral form around the optical axis Z of the optical element 40. Therefore, the wiring 80 transfers smoothly from an initial state (almost planar surface state) in a circular form as shown in FIG. 10 and FIG. 11 to an extending state (stereoscopic state) in a spiral form that is extended in the optical axis Z direction as shown in FIG. 7, and transforms following the extension of the lens barrel 20 without disturbing the extending operation of the lens barrel 20.

Further, the movable part 81 is disposed along an internal surface of the barrel body 30, and is transformable in a manner to avoid the optical path P1 of a bundle of rays passing through the optical element 40. As a result, the movable part 81 extends to creep along the internal surface of the barrel body 30, which reduces a concern about a possibility that the movable part 81 will protrude into the optical path P1 of a bundle of rays passing through the optical element 40 at the time of transformation.

In addition, in association with an extending operation of the lens barrel 20, the optical element 40 inside the lens barrel 20 also moves as appropriate in the optical axis Z direction. Further, when a user operates the optical zooming button 18B, the lens driving section 65A is driven by the lens barrel control section 65 in response to this operation, which displaces the optical element 40 in the optical axis Z direction.

Also in this case, the wiring 80 is inserted into the barrel body 30, and at least a part of the wiring 80 has a three-dimensional curve shape, more specifically a spiral form, that is capable of extending and contracting in the optical axis Z direction of the optical element 40, which reduces a concern about a possibility that the transformation of the movable part 81 will disturb traveling of the optical element 40 or the optical path P1.

At the photographing time, a subject image enters the optical element 40 inside the lens barrel 20 to be formed on an imaging surface of the image pickup device 50, and then an image signal is generated by the image pickup device 50. This image signal is provided as an input to the image signal processing section 64 via the amplifier 67. The image signal processing section 64 carries out a predetermined processing operation for the incoming image signal, and provides a resultant signal to the image recording/reproducing circuit section 61. In such a manner, the image recording/reproducing circuit section 61 outputs a signal corresponding to the subject image to the monitor driving section 66, the embedded memory 62, or the external memory 63. As a result, an image corresponding to the subject image is displayed on the display section 17 via the monitor driving section 66. Alternatively, an output signal is recorded on the embedded memory 62 or the external memory 63.

At the time of proximity photographing (macro photographing), a power is supplied to the illuminating device 70 via the wiring 80, and a subject is illuminated brightly with light from the illuminating device 70.

When a user presses the power button 15 to turn the power off, the lens barrel 20 automatically returns to the storing position (collapsible position) 30B shown in FIG. 1.

Also in this case, the wiring 80 is inserted into the barrel body 30, and at least a part of the wiring 80 has a three-dimensional curve shape, more specifically a spiral form, that is capable of extending and contracting in the optical axis Z direction of the optical element 40. Therefore, the wiring 80 transfers smoothly from an extending state (stereoscopic state) in a spiral form that is extended in the optical axis Z direction as shown in FIG. 7 to an initial state (almost planar surface state) in a circular form as shown in FIG. 10 and FIG. 11, and transforms following the retreat of the lens barrel 20 without disturbing the retreating operation of the lens barrel 20.

As described above, in this embodiment of the present disclosure, at least a part of the wiring 80 has a three-dimensional curve shape capable of extending and contracting in the optical axis Z direction of the optical element 40, and thus it is possible to transform the wiring 80 from the initial state as shown in FIG. 10 and FIG. 11 from the extending state as shown in FIG. 7, or vice versa in association with extension and retreat of the lens barrel 20. This makes it possible to improve the transformation properties of the wiring 80, as well as to establish a configuration for supplying electric power that allows the wiring 80 to be transformed without interfering with the extending and contracting operation of the lens barrel 20 and the optical path P1.

In particular, the movable part 81 is disposed in a spiral form centering around the optical axis Z of the optical element 40, which reduces a concern about a possibility of disturbing the extending and contracting operation of the lens barrel 20 and the optical path P1 irrespective of a transformation state (extending and contracting state) of the wiring 80.

### Modification Example 1

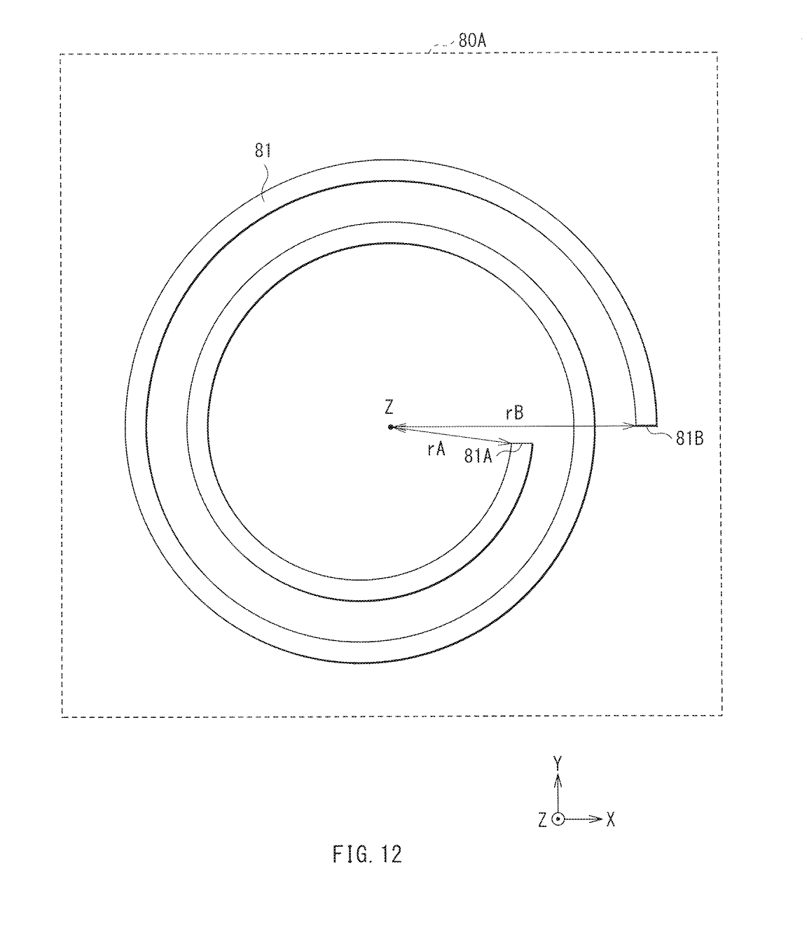

It is to be noted that, in the above-described embodiment of the present disclosure, the description is provided on a case where the movable part 81 takes a circular form of going around the optical axis Z of the optical element 40 by one turn in plane of a piece of the flexible wiring board 80A as shown in FIG. 8. However, the movable part 81 may take a volute form of going around the optical axis Z of the optical element 40 by more than one turn (for example, two turns in FIG. 12) in plane of a piece of the flexible wiring board 80A as shown in FIG. 12. This makes it possible to flexibly deal with a case where a distance of the extending and contracting operation of the lens barrel 20 becomes long.

In this case, the volute form may preferably become smaller in diameter (rA<rB in FIG. 12) as it comes closer to the electronic component mounting section 82 (or the end 81A to be connected with the electronic component mounting section 82). This is because the barrel body 30 typically becomes smaller in diameter as it comes closer to the front end of the lens barrel 20. It is to be noted that since a diameter is made smaller by extending the spiral (coiled) movable part 81, the volute form may be made larger in diameter as it comes closer to the electronic component mounting section 82.

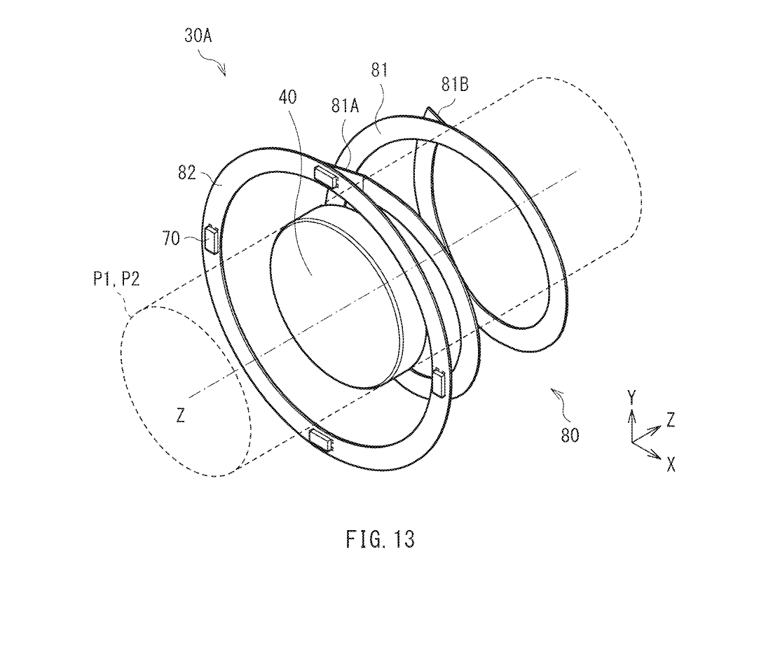

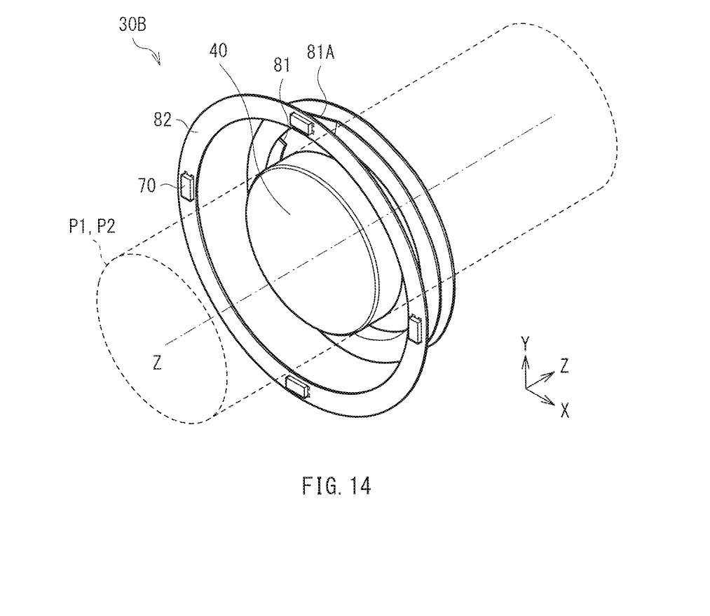

In this modification example, as shown in FIG. 13 and FIG. 14, the wiring 80 varies freely a length in the optical axis Z direction, and transforms following the extension of the lens barrel 20 without disturbing the extending operation of the lens barrel 20.

### Modification Example 2

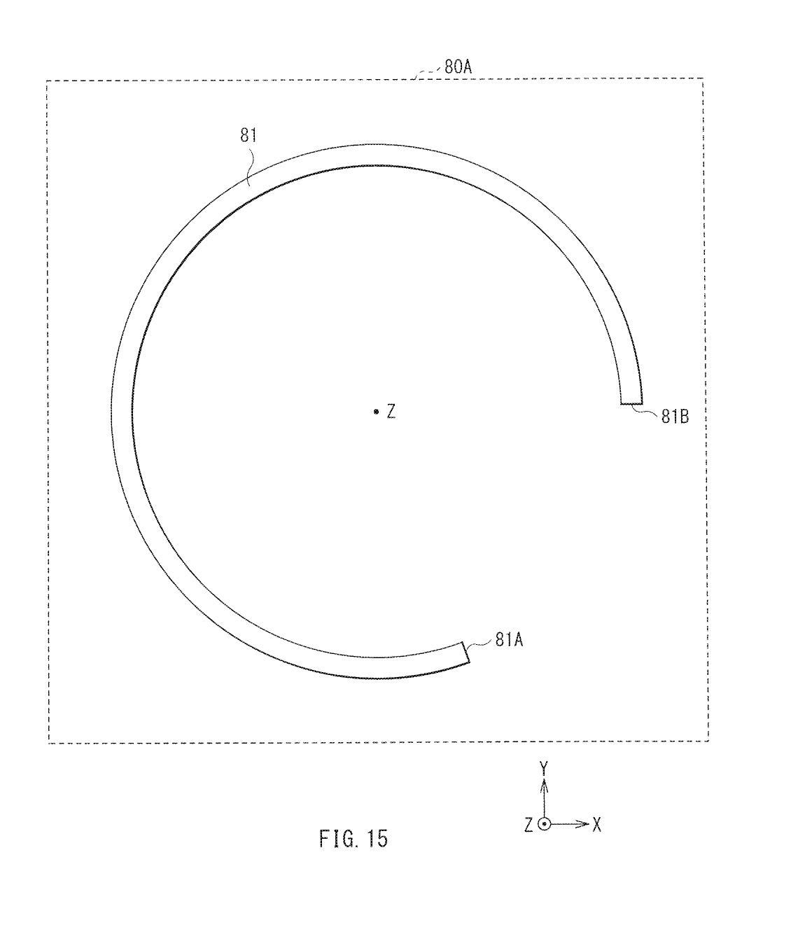

Further, for example, as shown in FIG. 15, the movable part 81 may be alternatively in an arc-like form of going around the optical axis Z of the optical element 40 by less than one turn in plane of a piece of a flexible wiring board 80A.

### Second Embodiment

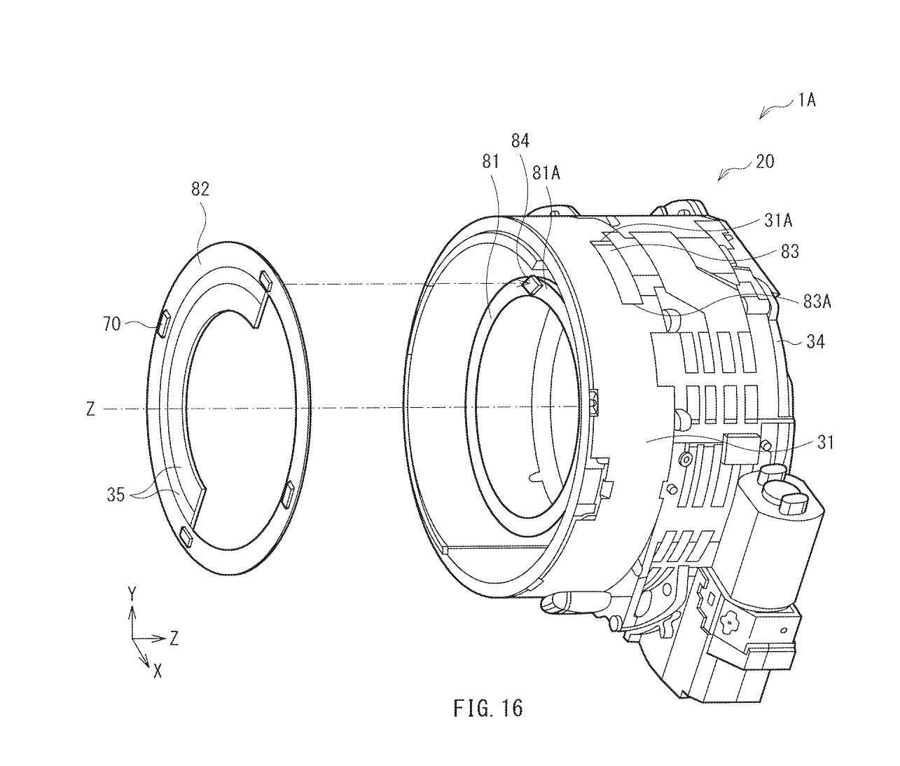

FIG. 16 shows a configuration of a lens barrel 20 according to a second embodiment of the present disclosure. In this embodiment, the front crowning member 35 of the lens barrel 20, the electronic component mounting section 82 of the wiring 80, and the illuminating device 70 are made removable with respect to the movable part 81 via a connector 84. This makes it possible to supply a power from the main unit 10 by inserting the wiring 80 into the barrel body 30, while configuring the illuminating device 70 as an accessory type. This eliminates the necessity for having a power source for supplying a power to the illuminating device 70 in the accessory, which allows reduction in weight of the accessory to be achieved. Further, a cable for supplying a power to the accessory externally is also unnecessary, leading to ease of use. Therefore, it is possible to achieve reduction in weight of an imaging apparatus 1A, and to improve ease of use and the external appearance. With the exception of this point, this imaging apparatus 1A has a configuration, a function, and effects similar to those in the above-described first embodiment.

### Third Embodiment

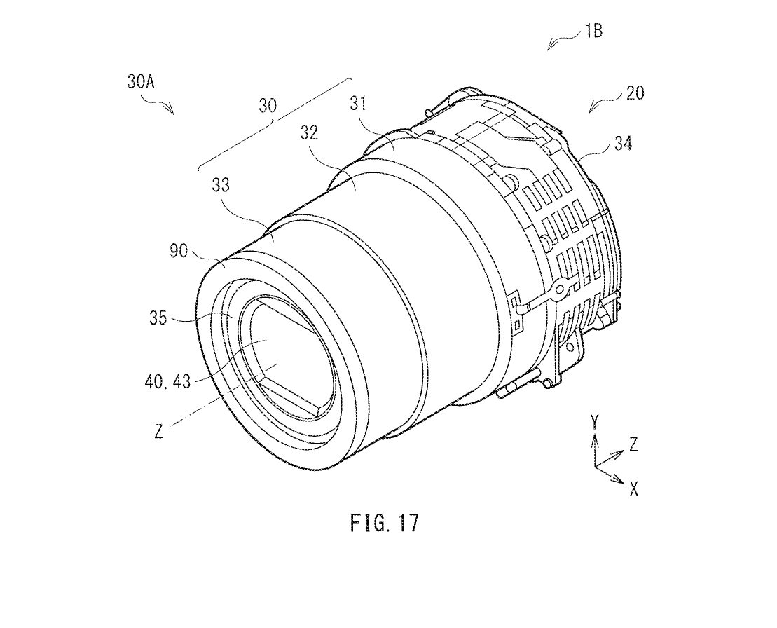

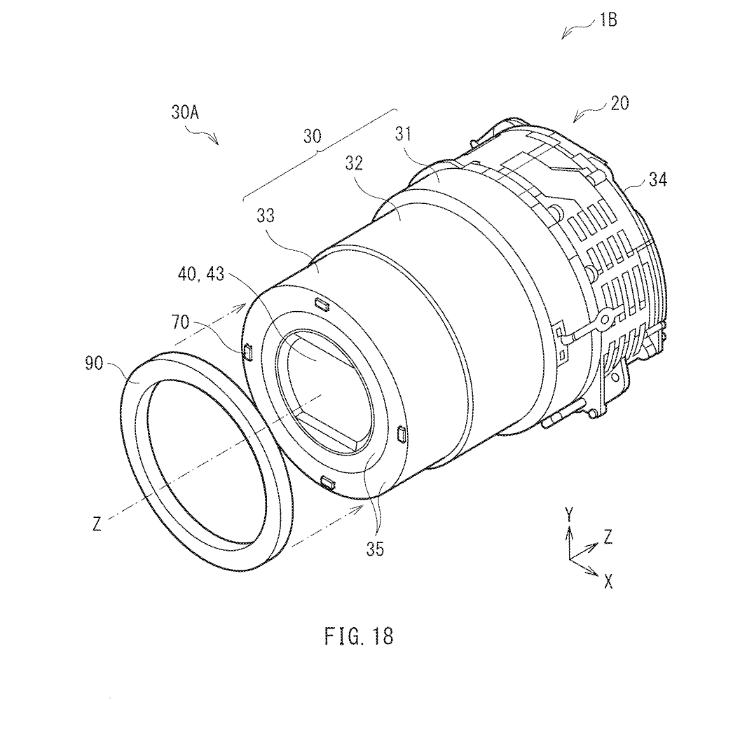

Each of FIG. 17 and FIG. 18 shows a configuration of a lens barrel 20 according to a third embodiment of the present disclosure. In this embodiment, a diffusion element (prism) 90 is disposed on the side where light from the illuminating device 70 is emitted out. The diffusion element 90 serves to diffuse the light from the illuminating device 70. As a result, even when the illuminating device 70 is a point light source, or the number of the illuminating device 70 is small, it is less likely that a shadow will be cast on a subject, and it is possible to illuminate a subject with light uniformly, which allows better photographing to be performed. With the exception of this point, this imaging apparatus 1B has a configuration, a function, and effects similar to those in the above-described first embodiment.

### Fourth Embodiment

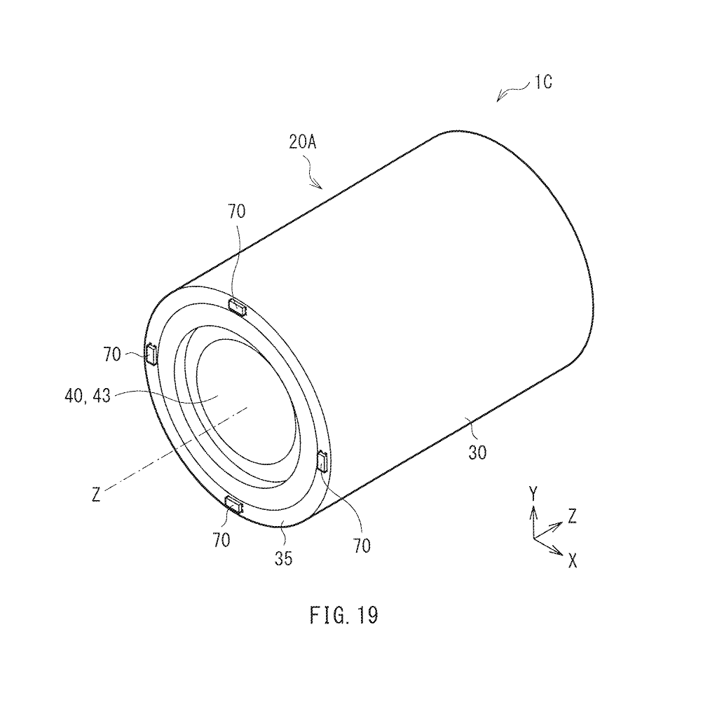

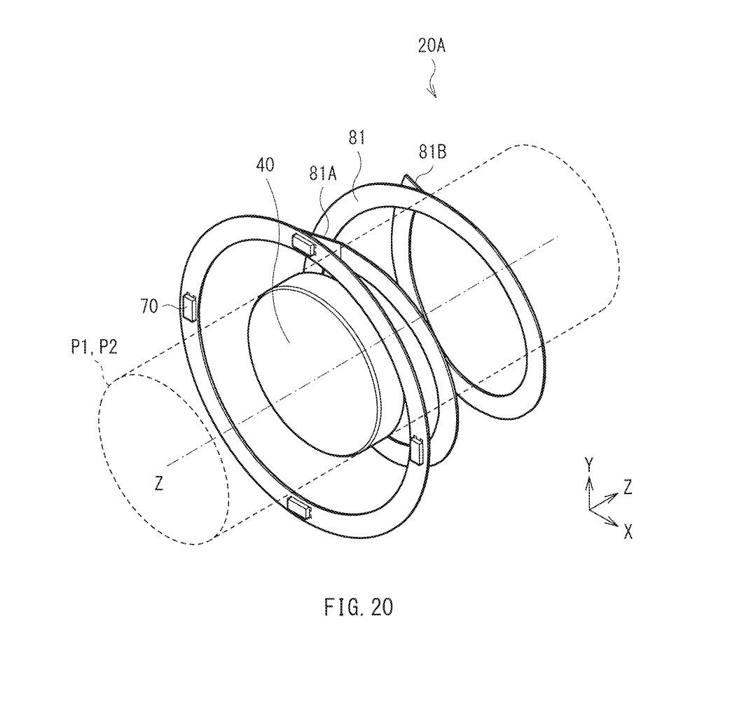

FIG. 19 shows an external appearance of a lens barrel 20A according to a fourth embodiment of the present disclosure. FIG. 20 shows an internal configuration of the lens barrel 20A illustrated in FIG. 19. This embodiment is an example where the above-described first embodiment is applied to the interchangeable lens barrel 20A. In other words, the lens barrel 20A according to this embodiment is mounted detachably with respect to the main unit 10. It is to be noted that the collapsible lens barrel 20 is used by extending it to the photographing position 30A, while the interchangeable lens barrel 20A is usable without extending it, or is usable by further extending it alternatively.

In a case of the interchangeable lens barrel 20A, the optical element 40 and the illuminating device 70 move in the optical axis Z direction in association with zooming operation, and the like, for example. As with the first embodiment, in association with the movement of the optical element 40 and the illuminating device 70, the wiring 80 transforms from the initial state as shown in FIG. 10 and FIG. 11 to the extending state as shown in FIG. 7, or vice versa. With the exception of this point, this imaging apparatus 1C has a configuration, a function, and effects similar to those in the above-described first embodiment.

The present disclosure is described thus far with reference to the embodiments. However, the present disclosure is not limited to the above-described embodiments, and various modifications may be made.

For example, in the above-described embodiments, the description is provided on an example where the illuminating device 70 is used as a macro light. However, the illuminating device 70 may be alternatively any illuminating device for other applications, such as a flash light, in addition to the macro light.

Further, for example, in the above-described embodiments, the description is provided on a case where the wiring 80 is provided to supply electric power to the illuminating device 70. However, the wiring 80 is usable widely for supplying a power to electrically-operated component parts that are provided on the front end of the lens barrel 20 in addition to the illuminating device 70. An example of a possible application may include supply of a power to an electrically-operated barrier unit of a video camera or a camcorder.

Moreover, for example, in the above-described embodiments, the description is provided on a case where the wiring 80 is configured of a flexible wiring board. However, the wiring 80 may be configured of a cable. Examples of a cable to be used for the wiring 80 may include a flexible flat cable, a flat cable, or a copper wire-clad electric wiring for electrical apparatuses. However, a cable to be used for the wiring 80 is not limited specifically so long as such a cable has the flexibility/plasticity and a capability of enduring transformation repeatedly.

In addition, for example, in the above-described embodiments, a configuration of the imaging apparatus 1 is described concretely. However, it is not necessary to provide all of the component parts, or any other component parts may be further provided.

Further, for example, in the above-described embodiments, the description is provided on a case where a compact digital camera is used as the imaging apparatus 1 as an example. However, the present disclosure is also applicable to a single-lens reflex camera.

It is possible to achieve at least the following configurations from the above-described example embodiments of the disclosure.

(1) A lens barrel, including:

a barrel body;

an optical element inside the barrel body; and

a wiring which is inserted inside the barrel body, and at least a part of which has a three-dimensional curve shape capable of extending and contracting in a direction of an optical axis of the optical element.
(2) The lens barrel according to (1), wherein the wiring includes a movable part, the movable part being disposed along an internal surface of the barrel body, and being transformable in a manner to avoid an optical path of a bundle of rays passing through the optical element.
(3) The lens barrel according to (2), wherein the movable part is disposed in a spiral form centering around the optical axis of the optical element.
(4) The lens barrel according to (2) or (3), wherein the movable part takes an arc-like form circling around the optical axis of the optical element by less than one turn, or a circular or volute form circling around the optical axis of the optical element by one or more turns, in plane of a piece of a flexible wiring board.
(5) The lens barrel according to any one of (2) to (4), wherein the wiring further includes an electronic component mounting section at a first end of the movable part, and an electronic component that receives power supplied via the wiring is mounted on the electronic component mounting section.
(6) The lens barrel according to (5), wherein the volute form becomes smaller in diameter as the volute form comes closer to the electronic component mounting section.
(7) The lens barrel according to (5) or (6), wherein the electronic component mounting section is connected with the movable part in an integrated manner.
(8) The lens barrel according to (5) or (6), wherein the electronic component mounting section is removable with respect to the movable part via a connector.
(9) The lens barrel according to any one of (5) to (8), wherein the electronic component is an illuminating device, and the illuminating device is disposed at a periphery of the optical element.
(10) The lens barrel according to (9), further including a diffusion element on a side at which light from the illuminating device is emitted out.
(11) The lens barrel according to any one of (1) to (10), wherein the wiring further includes a securing section at a second end of the movable part, and the securing section is fixed to the barrel body.
(12) The lens barrel according to (2) or (3), wherein the wiring is configured of a cable.
(13) The lens barrel according to any one of (1) to (12), wherein the barrel body is capable of performing extending and contracting operation.
(14) The lens barrel according to any one of (1) to (13), wherein the optical element is capable of moving in the direction of the optical axis, and the wiring is transformable in a manner to avoid a movement path of the optical element.
(15) An imaging apparatus provided with a lens barrel, the lens barrel including:

a barrel body;

an optical element inside the barrel body; and

a wiring which is inserted inside the barrel body, and at least a part of which has a three-dimensional curve shape capable of extending and contracting in a direction of an optical axis of the optical element.

(16) The imaging apparatus according to (15), further including a main unit,

wherein the lens barrel is a collapsible type capable of performing extending and contracting operation between a storing position where the barrel body is embedded into the main unit and a photographing position where the barrel body extends from the main unit.

(17) The imaging apparatus according to (15), further including a main unit,

wherein the lens barrel is an interchangeable type that is mounted detachably with respect to the main unit.

It should be understood by those skilled in the art that various modifications, combinations, sub-combinations and alterations may occur depending on design requirements and other factors insofar as they are within the scope of the appended claims or the equivalents thereof.

What is claimed is:

1. A lens barrel, comprising:
a barrel body;
an optical element inside the barrel body; and
a wiring which is inserted inside the barrel body, and at least a part of which has a three-dimensional curve shape capable of extending and contracting in a direction of an optical axis of the optical element.

2. The lens barrel according to claim 1, wherein the wiring includes a movable part, the movable part being disposed along an internal surface of the barrel body, and being transformable in a manner to avoid an optical path of a bundle of rays passing through the optical element.

3. The lens barrel according to claim 2, wherein the movable part is disposed in a spiral form centering around the optical axis of the optical element.

4. The lens barrel according to claim 2, wherein the movable part takes an arc-like form circling around the optical axis of the optical element by less than one turn, or a circular or volute form circling around the optical axis of the optical element by one or more turns, in plane of a piece of a flexible wiring board.

5. The lens barrel according to claim 2, wherein the wiring further includes an electronic component mounting section at a first end of the movable part, and an electronic component that receives power supplied via the wiring is mounted on the electronic component mounting section.

6. The lens barrel according to claim 5, wherein the volute form becomes smaller in diameter as the volute form comes closer to the electronic component mounting section.

7. The lens barrel according to claim 5, wherein the electronic component mounting section is connected with the movable part in an integrated manner.

8. The lens barrel according to claim 5, wherein the electronic component mounting section is removable with respect to the movable part via a connector.

9. The lens barrel according to claim 5, wherein the electronic component is an illuminating device, and the illuminating device is disposed at a periphery of the optical element.

10. The lens barrel according to claim 9, further comprising a diffusion element on a side at which light from the illuminating device is emitted out.

11. The lens barrel according to claim 1, wherein the wiring further includes a securing section at a second end of the movable part, and the securing section is fixed to the barrel body.

12. The lens barrel according to claim 2, wherein the wiring is configured of a cable.

13. The lens barrel according to claim 1, wherein the barrel body is capable of performing extending and contracting operation.

14. The lens barrel according to claim 1, wherein the optical element is capable of moving in the direction of the optical axis, and the wiring is transformable in a manner to avoid a movement path of the optical element.

15. An imaging apparatus provided with a lens barrel, the lens barrel comprising:
a barrel body;
an optical element inside the barrel body; and
a wiring which is inserted inside the barrel body, and at least a part of which has a three-dimensional curve shape capable of extending and contracting in a direction of an optical axis of the optical element.

16. The imaging apparatus according to claim 15, further comprising a main unit,
wherein the lens barrel is a collapsible type capable of performing extending and contracting operation between a storing position where the barrel body is embedded into the main unit and a photographing position where the barrel body extends from the main unit.

17. The imaging apparatus according to claim 15, further comprising a main unit,
wherein the lens barrel is an interchangeable type that is mounted detachably with respect to the main unit.
